(19) United States
(12) Patent Application Publication
(10) Pub. No.: US 2025/0197161 A1
(43) Pub. Date: Jun. 19, 2025

(54) ROLL TRANSFER DEVICE AND METHOD

(71) Applicant: SEMES CO., LTD., Chungcheongnam-do (KR)

(72) Inventor: Hong Woon SEO, Gyeonggi-do (KR)

(21) Appl. No.: 18/984,704

(22) Filed: Dec. 17, 2024

(30) Foreign Application Priority Data
Dec. 18, 2023 (KR) 10-2023-0184821

(51) Int. Cl. B65H 75/28; B65H 75/30

(52) U.S. Cl. CPC B65H 75/28; B65H 75/30; B65H 2402/53; B65H 2553/43

(57) ABSTRACT

A roll transfer device is provided, which makes it convenient to perform a centering work of a roll stocked in a left or right eccentric state to increase reliability of the centering work of the roll. The roll transfer device comprises a plurality of frame units constituting an external appearance; a pair of holding units spaced apart from each other in a first direction inside the frame unit, supporting a roll core seated thereon; a pair of elevating units disposed on both upper sides in the first direction inside the frame unit to elevate a roll in a second direction and connected to each other by a first plate; a pair of alignment units provided on the first plate and disposed on both sides in the first direction to align a position of the roll in the first direction; and a pair of transfer units transferring the roll, in which the roll core is seated on the pair of holding units, in a third direction by simultaneously moving the pair of holding units in the third direction, wherein the pair of alignment units linearly move along the first direction with different strokes to align the roll, in which the roll core is seated on the pair of holding units, in the first direction while being eccentric along the first direction.

### CROSS-REFERENCE TO RELATED APPLICATION

This application claims priority from Korean Patent Application No. 10-2023-0184821 filed on Dec. 18, 2023, in the Korean Intellectual Property Office and all the benefits accruing therefrom under 35 U.S.C. 119, the contents of which in its entirety are herein incorporated by reference.

### BACKGROUND

### Technical Field

The present disclosure relates to a roll transfer device and method.

### Description of the Related Art

Secondary batteries are batteries that can be used repeatedly through discharging that converts chemical energy into electrical energy and charging that converts electrical energy into chemical energy.

Examples of the secondary batteries include nickel-cadmium batteries, nickel-hydrogen batteries, lithium-ion batteries, or lithium-ion polymer batteries.

This secondary battery includes a cathode, an anode, an electrolyte and a separator, and stores and generates electricity by using a voltage difference between different cathode and anode materials.

Among methods of manufacturing a secondary battery, a method of manufacturing a lithium ion secondary battery includes stacking a first separator, an anode plate, a second separator and an anode plate, winding them multiple times to form an electrode assembly, sealing the electrode assembly in a case and injecting an electrolyte into the case.

In this case, the separator is provided and supplied in the form of a wound roll, and such a separator cannot increase a diameter due to material characteristics, whereby the roll should be frequently replaced in a winding process.

In this way, in order to replace the roll, when the roll wound with the separator is stocked, a worker classifies the roll depending on the type of the corresponding separator, and supplies the classified roll to a manufacturing device.

Meanwhile, a position and centering of the roll mounted on the manufacturing device should be accurately recognized so that a defect rate of a product may be reduced.

In this way, in order to accurately match the position and centering of the roll, a centering work is performed by directly pressurizing a roll core with the same force on both sides of the roll by using a cylinder. It was difficult to perform the centering work by pressurizing the roll core due to a heavy load of the roll and friction with the roll core, and the centering work may not be performed, whereby reliability of the centering work may be deteriorated.

### BRIEF SUMMARY

An object of the present disclosure is to provide a roll transfer device and method that makes it convenient to perform a centering work of a roll stocked in a left or right eccentric state to increase reliability of the centering work of the roll.

The objects of the present disclosure are not limited to those mentioned above and additional objects of the present disclosure, which are not mentioned herein, will be clearly understood by those skilled in the art from the following description of the present disclosure.

A roll transfer device according to one aspect of the present disclosure devised to achieve the above objects comprises a plurality of frame units constituting an external appearance; a pair of holding units spaced apart from each other in a first direction inside the frame unit, supporting a roll core seated thereon; a pair of elevating units disposed on both upper sides in the first direction inside the frame unit to elevate a roll in a second direction and connected to each other by a first plate; a pair of alignment units provided on the first plate and disposed on both sides in the first direction to align a position of the roll in the first direction; and a pair of transfer units transferring the roll, in which the roll core is seated on the pair of holding units, in a third direction by simultaneously moving the pair of holding units in the third direction, wherein the pair of alignment units linearly move along the first direction with different strokes to align the roll, in which the roll core is seated on the pair of holding units, in the first direction while being eccentric along the first direction.

A roll transfer device according to another aspect of the present disclosure devised to achieve the above objects comprises a plurality of holding units spaced apart from each other in a first direction, supporting a roll core seated thereon; a pair of elevating units disposed on both upper sides in the first direction to elevate a roll in a second direction and connected to each other by a connection plate; a pair of alignment units provided on the connection plate and disposed on both sides in the first direction to align a position of the roll in the first direction; and a pair of transfer units transferring the roll, in which the roll core is seated on the pair of holding units, in a third direction by simultaneously moving the pair of holding units in the third direction, wherein the alignment unit includes a pair of LM guide rails spaced apart from each other along the third direction on the connection plate and extended along the first direction, a moving plate coupled to the pair of LM guide rails through one or more LM blocks so as to linearly move along the first direction, a pair of support blocks provided to be adjacent to the LM guide rail on the connection plate and spaced apart from each other along the first direction, a rotating shaft connecting the pair of support blocks, a driving motor connected to the rotating shaft through a coupler on the connection plate to transfer a driving force to the rotating shaft, a carrier disposed on the rotating shaft and coupled to a lower surface of the moving plate, an extension frame provided on the lower surface of the moving plate and extended downward by passing through an opening formed at a position, at which the pair of LM guide rails are spaced apart from each other, in the connection plate, a hand block provided in the extension frame and inserted into the roll core seated on an upper portion of the holding unit, and an inner diameter detection sensor provided inside the hand block to detect an inner diameter of the roll core, when the roll core is seated on the pair of holding units, the moving plate linearly moves in the first direction by driving of the driving motor and at the same time the extension frame and the hand block linearly move in the first direction to insert the hand block into the roll core, when the inner diameter detection sensor detects the inner diameter of the roll core, driving of the driving motor is stopped so that the insertion of the hand block is stopped, the roll is elevated by the pair of elevating units in a state that the hand block is inserted into the roll core, in a state that the roll is eccentric along the first direction, a distance from an initial position of each of the roll cores on both sides in the first direction to a position where the inner diameter detection sensor detects the inner diameter of the roll core is calculated so that the driving motor of each of the pair of alignment units is driven with different strokes, and the fifth plate, the extension frame and the hand block of each of the pair of alignment units move along the first direction with different strokes together with the roll by the driving motor to align the roll, which is eccentric along the first direction, in the first direction.

A roll transfer method according to one aspect of the present disclosure devised to achieve the above objects comprises seating a roll core on a pair of holding units at a position between the pair of holding units spaced apart from each other in a first direction by an unmanned transport vehicle or a forklift to face each other, inserting a hand block of each of a pair of alignment units disposed at both sides of the roll core into the roll core at both sides of the roll in the first direction, elevating the roll in the second direction by a pair of elevating units disposed to be spaced apart from each other in the first direction in a state that the hand block is inserted into the roll core, aligning the roll along the first direction by driving each of the pair of alignment units with different scrolls to correspond to an initial position of each of the roll cores on both sides of the roll eccentric along the first direction, seating the roll core on the pair of holding units again by descending the roll, which is aligned along the first direction, in the second direction by descending of the pair of elevating units along the second direction, recognizing a unique identification number for a material wound on the roll through a barcode reader while rotating the roll core by rotation of any one of a pair of seating rollers respectively provided in the pair of holding units to seat the roll thereon, and transferring the roll to a stacker crane by moving the pair of holding units in the third direction by movement of the pair of transfer units, in which the pair of holding units are respective disposed, in the third direction to move the roll, which is seated on the pair of holding units, in the third direction.

Details of the other embodiments are included in the detailed description and drawings.

In the roll transfer device and method according to some embodiments of the present disclosure, in a state that a roll stocked in a left or right eccentric state is elevated through an elevating unit to minimize friction, instead of pressing a roll core with the same force from both left and right sides, a distance detected by a detection sensor is calculated from an initial position in which the roll core is stocked, so that alignment units on both left and right sides move in a left-right direction with different strokes together with the roll to align the roll, thereby making a centering work convenient and improving position accuracy during a transfer operation to increase reliability in the centering work of the roll.

The effects according to the embodiment of the present disclosure are not limited to those mentioned above, and more various effects are included in the following description of the present disclosure.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic perspective view illustrating a roll of a roll transfer device according to some embodiments of the present disclosure;

FIG. 2 is a schematic perspective view illustrating a roll transfer device according to some embodiments of the present disclosure;

FIG. 3 is a schematic partial perspective view illustrating a holding unit and a transfer unit of a roll transfer device according to some embodiments of the present disclosure;

FIG. 4 is a schematic partial perspective view illustrating a holding unit of a roll transfer device according to some embodiments of the present disclosure;

FIGS. 5 and 6 are schematic partial perspective views illustrating an elevating unit and an alignment unit of a roll transfer device according to some embodiments of the present disclosure;

FIG. 7 is a schematic perspective view illustrating an elevating unit of a roll transfer device according to some embodiments of the present disclosure;

FIG. 8 is a schematic perspective view illustrating an alignment unit of a roll transfer device according to some embodiments of the present disclosure;

FIG. 9 is a schematic perspective view illustrating a transfer unit of a roll transfer device according to some embodiments of the present disclosure; and

FIG. 10 is a flow chart illustrating a roll transfer method according to some embodiments of the present disclosure.

### DETAILED DESCRIPTION OF THE DISCLOSURE

Hereinafter, the preferred embodiment of the present disclosure will be described in detail with reference to the accompanying drawings. Advantages and features of the present disclosure and methods of achieving the advantages and features will be apparent from the following embodiments that will be described in more detail with reference to the accompanying drawings. It should be noted, however, that the present disclosure is not limited to the following embodiments and may be implemented in various forms. The embodiments are provided only to disclose the present disclosure and let those skilled in the art understand the scope of the present disclosure. In the drawings, the embodiments of the present disclosure are defined by the scope of claims. The same reference numerals denote the same elements throughout the specification.

The terms used herein are for the purpose of embodiments and are not intended to be limit the present disclosure. In the present disclosure, unless referred to the contrary, the singular forms are intended to include the plural forms. The terms “comprises” and/or “comprising” used herein specify the presence of stated elements, steps, operations and/or targets but do not preclude the presence or addition of one or more other elements, steps, operations and/or targets.

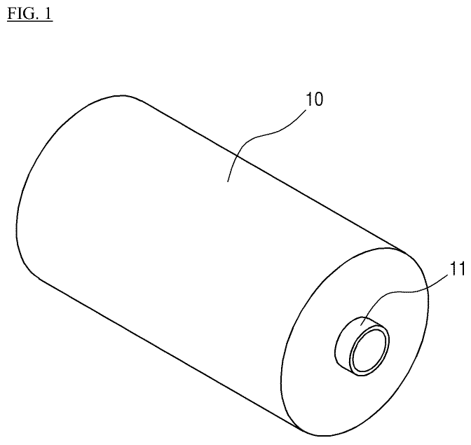

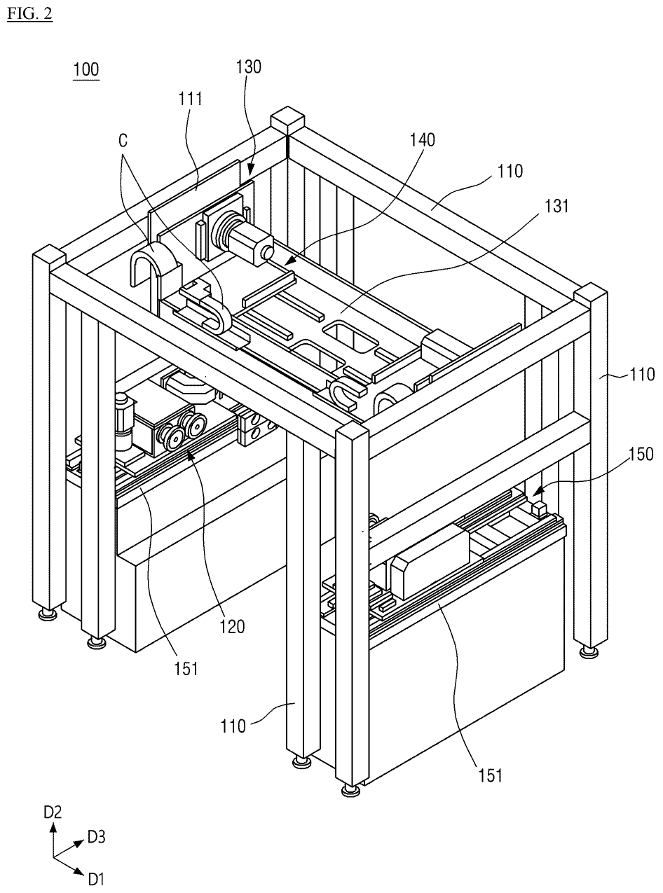

FIG. 1 is a schematic perspective view illustrating a roll of a roll transfer device according to some embodiments of the present disclosure. FIG. 2 is a schematic perspective view illustrating a roll transfer device according to some embodiments of the present disclosure.

Referring to FIGS. 1 and 2, the roll transfer device 100 according to some embodiments of the present disclosure may include a frame unit 110, a holding unit 120, an elevating unit 130, an alignment unit 140 and a transfer unit 150.

A plurality of frame units 110 may be disposed along a first direction D1, a second direction D2 and a third direction D3 so as to form an external appearance of the roll transfer device 100 according to some embodiments of the present disclosure.

The frame unit 110 may have a shape that is open forward and backward in the third direction D3. That is, a roll 10 stocked from the front by an automatic guided vehicle (AGV) or a forklift is transferred along the third direction D3 and then transferred to a stacker crane at the rear.

The frame unit 110 may include a third plate 111.

The third plate 111 may be provided inside the frame unit 110 for the arrangement of the elevating unit 130. The third plate 111 may be disposed above both sides along the first direction D1 and the second direction D2 inside the frame unit 110. The third plate 111 may be provided with a pair of first LM guide rails 132 of the elevating unit 130.

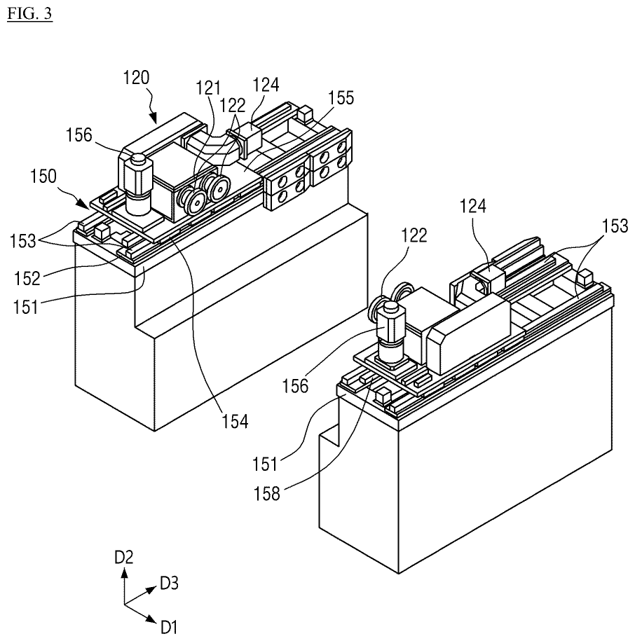

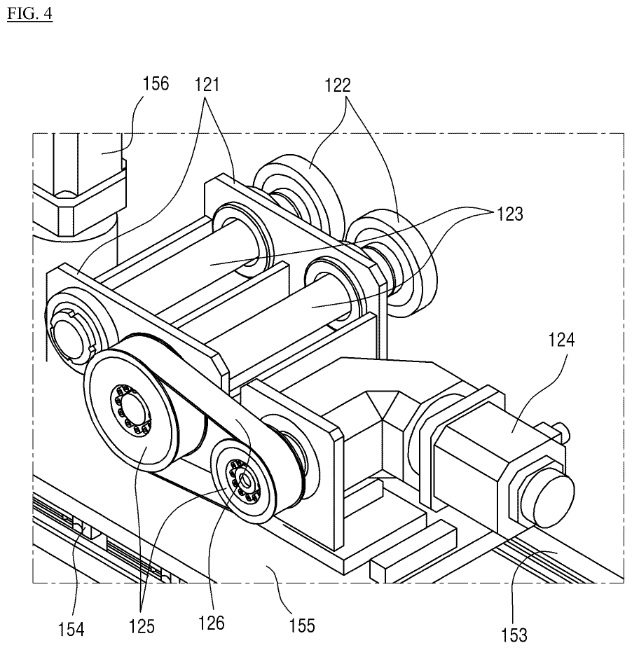

FIG. 3 is a schematic partial perspective view illustrating a holding unit and a transfer unit of a roll transfer device according to some embodiments of the present disclosure. FIG. 4 is a schematic partial perspective view illustrating a holding unit of a roll transfer device according to some embodiments of the present disclosure.

The holding unit 120 may be disposed inside the plurality of frame units 110. The holding units 120 may be provided in pairs spaced apart from each other in the first direction D1. The holding unit 120 may have a shape to support a roll core 11 seated thereon.

The holding unit 120 may include a second plate 121, a seating roller 122 and a first driving motor 124.

The second plate 121 may be provided in pairs spaced apart from each other in the first direction D1. The second plate 121 may have a shape in which the seating roller 122 is installed to be supported. The second plate 121 may rotatably support the seating roller 122.

A shaft 123 of the seating roller 122 may pass through and be coupled to the pair of second plates 121. The pair of second plates 121 may be disposed on a worktable 151.

The pair of second plates 121 may move along the third direction D3 while being disposed on the worktable 151. In this case, the third direction D3 may be a direction orthogonal to the first direction D1 on a plane.

The seating roller 122 may be rotatably coupled to the second plate 121 by the shaft 123. The seating roller 122 may be disposed in pairs adjacent to each other or to be in surface contact with each other along the third direction D3.

The seating roller 122 may be rotated. The pair of seating rollers 122 may be rotated, respectively. The roll core 11 seated on the seating roller 122 may be rotated by rotation of the pair of seating rollers 122.

Any one of the pair of seating rollers 122 may be rotated. Since the pair of seating rollers 122 are disposed to be adjacent to each other or to be in surface contact with each other, any one of the pair of seating rollers 122 is rotated so that the other one thereof may be also rotated.

While the roll core 11 is rotated by the rotation of any one of the pair of seating rollers 122, the other seating roller 122 may be also rotated. The pair of seating rollers 122 may support the rotation of the roll core 11.

The first driving motor 124 may be disposed on the worktable 151. The first driving motor 124 may be connected to the seating roller 122.

The first driving motor 124 is provided to rotate the seating roller 122. The first driving motor 124 may be connected to a controller. The first driving motor 124 may be actuated by the controller to rotate the seating roller 122. The first driving motor 124 may be connected to the shaft 123 of any one of the pair of seating rollers 122 to rotate the seating roller 122.

The first driving motor 124 may be connected to the shaft 123 of the seating roller 122 through a driving pulley 125 and a timing belt 126. The driving pulley 125 and the timing belt 126 may transfer a driving force from the first driving motor 124 to the shaft 123 of the seating roller 122 to rotate the seating roller 122.

The roll transfer device 100 according to some embodiments of the present disclosure may further include a seating detection sensor. The holding unit 120 may include a seating detection sensor.

The seating detection sensor may detect seating of the roll core 11. That is, the seating detection sensor may detect that the roll core 11 of the roll 10 stocked in the roll transfer device 100 is seated on the pair of seating rollers 122 by an unmanned transport vehicle, a forklift or the like.

Also, the seating detection sensor may detect that the roll 10 of which position according to the first direction D1 is aligned by the alignment unit 140 is lowered by the elevating unit 130 and then seated on the pair of seating rollers 122.

The seating detection sensor may transfer a signal for sensing that the roll core 11 is seated to the controller. The seating detection sensor may have a shape disposed on the second plate 121 or the seating roller 122.

The holding unit 120 may move along the third direction D3 on the worktable 130 of the transferring unit 150. Therefore, the roll 10 in which a unique identification number for a material wound on the roll 10 is recognized may be transferred to the stacker crane.

The roll transfer device 100 according to some embodiments of the present disclosure may further include a barcode reader. The barcode reader may recognize the unique identification coat for the material wound on the roll 10. The barcode reader may be connected to the controller. The barcode reader may have a shape disposed on the frame unit 110 or the worktable 151. The barcode reader may be disposed above the holding unit 120.

The barcode reader may recognize the unique identification number at a certain position by the rotation of the roll 10 according to the rotation of the pair of seating rollers 122. That is, the roll 10 is also rotated by the rotation of the roll core 11 according to the rotation of the pair of seating rollers 122 in a state that the position of the roll 10 in the first direction 10 is aligned by the alignment unit 140, so that the barcode reader may uniformly recognize the unique identification number at a specific position.

This makes it possible to conveniently recognize the unique identification code for the material wound on the roll 10 even though the roll 10 carried and stocked in the roll transfer device 100 is not stocked in place.

In this way, the barcode reader may recognize the unique identification code of the roll 10 in a state that the roll 10 is aligned in the first direction D1 and even in a state that the roll 10 is not aligned along the first direction 10.

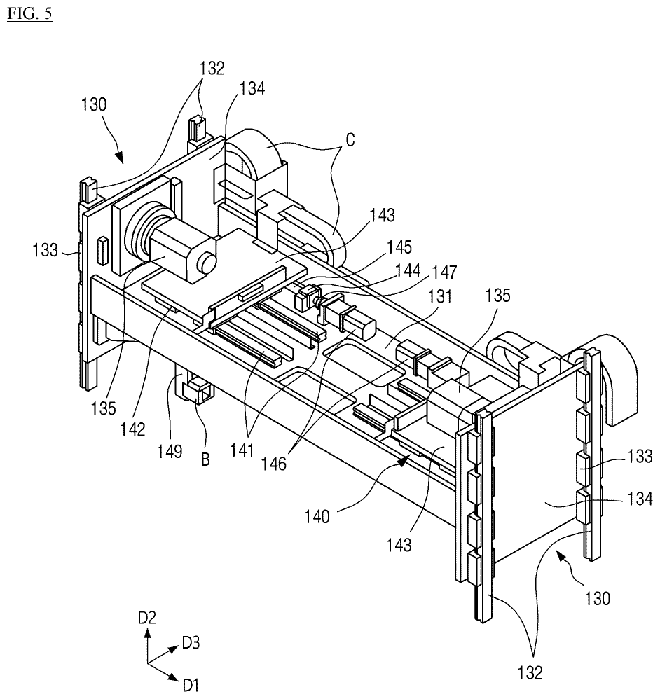

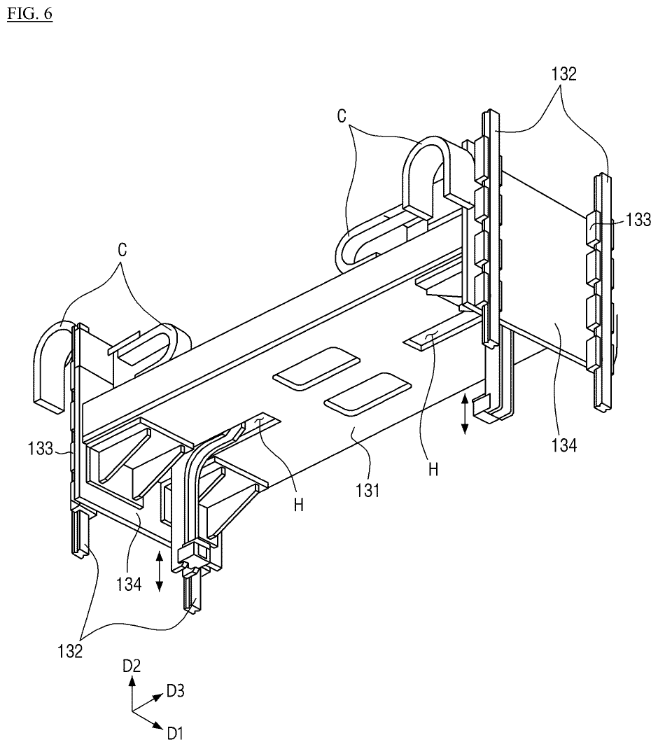

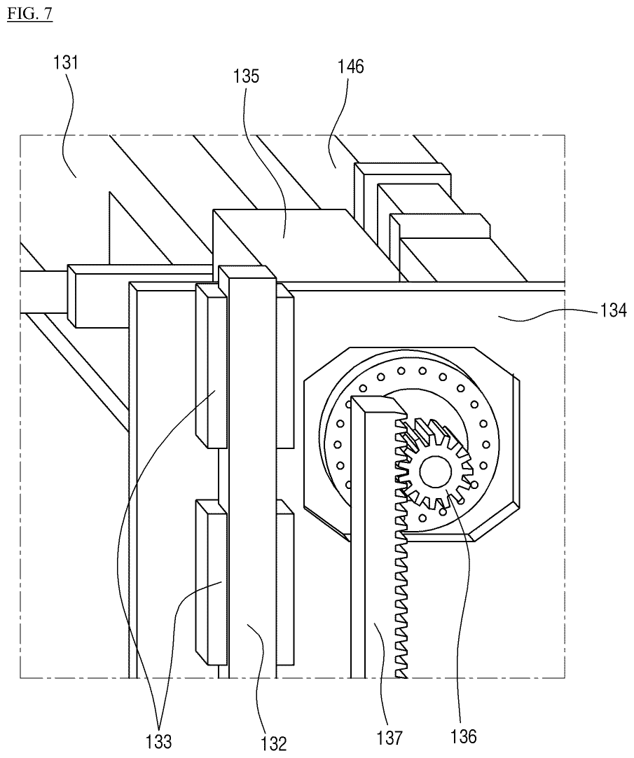

FIGS. 5 and 6 are schematic partial perspective views illustrating an elevating unit and an alignment unit of a roll transfer device according to some embodiments of the present disclosure. FIG. 7 is a schematic perspective view illustrating an elevating unit of a roll transfer device according to some embodiments of the present disclosure.

The elevating unit 130 may be disposed on an upper portion inside the frame unit 110. The elevating unit 130 may be disposed to be spaced apart from another one along the first direction D1 inside the frame unit 110. The elevating unit 130 may be provided in pairs disposed on both upper sides inside the frame unit 110 along the first direction D1 and the second direction D2.

The pair of elevating units 130 may be connected to each other by a first plate 131 (connection plate). In this case, the first plate 131 (connection plate) may include an opening H formed at a position where a pair of second LM guide rails 141 of the alignment unit 140 are spaced apart from each other. An extension frame 149 of the alignment unit 140 may be extended downward through the opening H formed in the first plate 131 (connection plate).

The pair of elevating units 130 may lift the roll 10 in which the roll core 11 is seated on the pair of holding units 120.

The elevating unit 130 may include a first LM guide rail 132, a fourth plate 134, a second driving motor 135 and a first rack 137.

The first LM guide rail 132 may be provided on the third plate 111 disposed on both upper sides inside the plurality of frame units 110 along the first direction D1 and the second direction D2. The first LM guide rail 132 may be provided in pairs spaced apart from each other along the third direction D3. The first LM guide rail 132 may have a shape extended along the second direction D2.

The fourth plate 134 may be disposed on the first LM guide rail 132. The fourth plate 134 may be disposed to be linearly movable along the second direction D2. The fourth plate 134 may be coupled to the first LM guide rail 132 through one or more first LM blocks 133.

The second driving motor 135 may be provided on the fourth plate 134. The second driving motor 135 may lift the fourth plate 134. The second driving motor 135 may be connected to the controller.

The second driving motor 135 may lift the fourth plate 134 in a state that a hand block B of the alignment unit 140 is inserted into the roll core 11. The second driving motor 135 may serve as a power source for elevating the roll 10.

The pair of elevating units 130, the first plate 131 (connection plate) connecting the elevating units and the alignment unit 140 may be integrally elevated by actuation of the second driving motor 135.

The second driving motor 135 may include a first pinion 136 provided outside the fourth plate 134 along the first direction D1.

The first rack 137 may be provided outside the fourth plate 134 along the first direction D1. The first rack 137 may have a shape extended in the second direction D2.

The first rack 137 may constitute gear engagement with the first pinion 136 by the actuation of the second driving motor 135 by the controller.

The fourth plate 134 may be elevated by gear engagement of the first rack 137 and the first pinion 136. The fourth plate 134 may be elevated in a state that the hand block B is inserted into the roll core 11 by gear engagement of the first rack 137 and the first pinion 135.

In this way, the elevating of the roll 10 according to the elevating of the fourth plate 134 by the actuation of the second driving motor 135 may be limited by a dog sensor. The dog sensor may be connected to the controller.

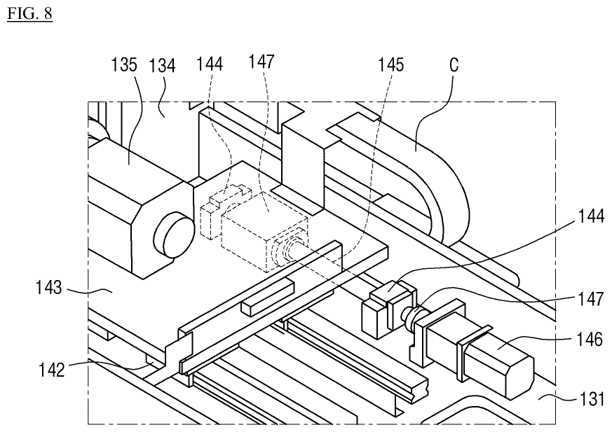

FIG. 8 is a schematic perspective view illustrating an alignment unit of a roll transfer device according to some embodiments of the present disclosure.

Referring to FIGS. 5, 6 and 8, the alignment unit 140 may be provided on the first plate 131 (connection plate). The alignment unit 140 may be provided in pairs disposed on both sides along the first direction D1. The alignment unit 140 aligns the position of the roll 10 in the first direction D1.

The pair of alignment units 140 may linearly move along the first direction D1 with different strokes, so that the pair of alignment units 140 may be stocked in an eccentric state along the first direction D1 to align the roll 10, in which the roll core 11 is seated on the pair of holding units 120, in the first direction D1.

The alignment unit 140 may include a second LM guide rail 141, a fifth plate 143 (moving plate), a support block 144, a rotating shaft 145, a third driving motor 146, a carrier 148, an extension frame 149, a hand block B and an inner diameter detection sensor S.

The second LM guide rail 141 may be disposed on the first plate 131 (connection plate). The second LM guide rail 141 may be provided in pairs spaced apart from each other along the third direction D3. The second LM guide rail 141 may have a shape extended along the first direction D1.

The fifth plate 143 (moving plate) may be coupled to the second LM guide rail 141. The fifth plate 143 (moving plate) may be coupled to one or more second LM blocks 142. One or more second LM blocks 142 may be coupled to the second LM guide rail 141. The fifth plate 143 (moving plate) may be disposed to be linearly movable along the first direction D1.

The support block 144 may be fixed on the first plate 131 (connection plate). The support block 144 may be provided to be adjacent to the second LM guide rail 141. The support block 144 may be provided in pairs spaced apart from each other along the first direction D1.

A bearing is provided inside the pair of support blocks 144. One end portion and the other end portion of the rotating shaft 145 in the first direction D1 are rotatably mounted on the bearings provided in the pair of support blocks 144, respectively. A pair of bearings fix the rotating shaft 145 to a certain position that is not eccentric. The pair of bearings support a weight of the rotating shaft 145 that is being rotated and a load applied to the rotating shaft 145.

The rotating shaft 145 connects the pair of support blocks 144 in the first direction D1. The rotating shaft 145 may move the carrier 148 in the first direction D1 through the driving force transferred by the third driving motor 146.

The rotating shaft 145 may have a ball screw shape. The rotating shaft 145 may convert a rotation movement of the third driving motor 146 into a linear movement of the carrier 148 disposed on the rotating shaft 145. The rotating shaft 145 may be rotated by the third driving motor 146 to linearly move the carrier 148 in one side or the other side along the first direction D1 toward the support block 144 on one side or the support block 144 on the other side along the first direction D1.

The third driving motor 146 may be fixed on the first plate 131 (connection plate). The third driving motor 146 is connected to any one of the pair of supporting blocks 144 to transmit the driving force to the rotating shaft 145.

The third driving motor 146 is connected to the rotating shaft 145 through a coupler 147. The coupler 147 may hold the rotating shaft 145 and rotate the rotating shaft 145 in a certain shaft direction even though concentricity (concentric axis) of the rotating shaft 145 is shifted during the movement of the carrier 148.

The third driving motor 146 generates a rotational force and transfers the driving force to the rotating shaft 145 having a ball screw shape. The third driving motor 146 may be connected to the controller. The controller may actuate the third driving motor 146.

The carrier 148 may be coupled to a lower surface of the fifth plate 143 (moving plate). The carrier 148 may be disposed on the rotating shaft 145 and may linearly move in the first direction D1 through the driving force transferred by the third driving motor 146. The fifth plate 143 (moving plate) may linearly move in the first direction D1 in a state that the fifth plate 143 (moving plate) is disposed on the second LM guide rail 141 by the linear movement of the carrier 148.

The extension frame 149 may be fixed to the lower surface of the fifth plate 143 (moving plate). The extension frame 149 may be disposed at a position where the pair of second LM guide rails 141 are spaced apart from the lower surface of the fifth plate 143 (moving plate). The extension frame 149 may have a shape that is extended downward by passing through the opening H of the first plate 131 (connection plate).

The hand block B may be provided on the extension frame 149. The hand block B may be disposed on a lower end of the extension frame 149. The hand block B may be inserted into the roll core 11 seated on the upper portion of the holding unit 120 by the actuation of the third driving motor 146. The hand block B may be inserted into the roll core 11 seated on the pair of seating rollers 122.

The inner diameter detection sensor S may be provided inside the hand block B. The inner diameter detection sensor S may detect an inner diameter of the roll core 11 in the process of inserting the hand block B into the roll core 11. The inner diameter detection sensor S may be connected to the controller.

That is, when the roll core 11 is seated on the pair of holding units 120 facing each other in the first direction D1, the fifth plate 143 (moving plate) may linearly move in the first direction D1 by driving of the third driving motor 146 and at the same time the extension frame 149 and the hand block B may also linearly move in the first direction D1 integrally with the fifth plate 143 (moving plate) so that the hand block B may be inserted into the roll core 11.

When the hand block B is inserted into the position where the inner diameter detection sensor S may detect the inner diameter of the roll core 11, the controller may receive an inner diameter detection signal of the roll core 11 of the inner diameter detection sensor S and stop the driving of the third driving motor 146 to stop the insertion of the hand block B.

The controller lifts the roll 10 by actuating the pair of elevating units 130 in a state that the hand block B is inserted into the roll core 11.

The controller calculates a distance from an initial position of each of the roll cores 11 on both sides in the first direction D1 to a position where the inner diameter detection sensor S detects the inner diameter of the roll core 11 in a state that the roll 10 is eccentric along the first direction D1.

The controller allows the third driving motor 146 of each of the pair of alignment units 140 to be driven with different strokes in accordance with the calculated distance. The fifth plate 143 (moving plate), the extension frame 149 and the hand block B of each of the pair of alignment units 140 also move with different strokes integrally along the first direction D1 together with the roll 10 by the third driving motor 146 that is driven with different strokes, so that the roll 10 eccentric along the first direction D1 may be aligned in the first direction D1.

The roll transfer device 100 according to some embodiments of the present disclosure may further include a cable veyor coupled to the pair of elevating units 130 and the pair of alignment units 140 through brackets, respectively.

The cable veyor C may have a shape of preventing a cable disposed in the roll transfer device 100 from being detached and supporting the cable in the process of aligning the roll 10 in the first direction D1 and elevating the roll 10 in the second direction D2.

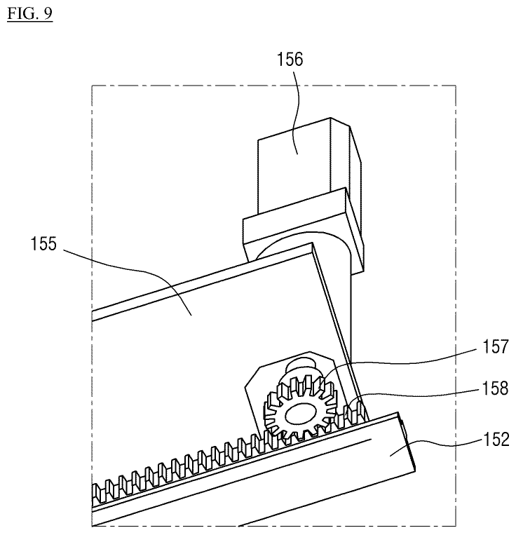

FIG. 9 is a schematic perspective view illustrating a transfer unit of a roll transfer device according to some embodiments of the present disclosure.

Referring to FIGS. 3 and 9, the transfer unit 150 may be provided in pairs spaced apart from each other along the first direction D1 to simultaneously move the pair of holding units 120 in the third direction D3.

The pair of transfer units 150 may transfer the roll 10, in which the roll cores 11 on both sides in the first direction D1 are seated on the pair of holding units 120, in the third direction D3.

Each of the pair of transfer units 150 may include a worktable 151, a mounting frame 152, a third LM guide rail 153, a sixth plate 155, a fourth driving motor 156, a second pinion 157 and a second rack 158.

The worktable 151 may be provided in pairs spaced apart from each other in the first direction D1. The worktable 151 may have a shape extended in the third direction D3. The pair of holding units 120 may be disposed on upper surfaces of the pair of worktable 151, respectively.

The mounting frame 152 may be provided in pairs spaced apart from each other in the first direction D1 on the upper surface of the worktable 151. The mounting frame 152 may have a shape extended in the third direction D3.

The third LM guide rail 153 may be disposed on the upper surface of each of the pair of mounting frames 152. The third LM guide rail 153 may have a shape extended along the third direction D3.

The sixth plate 155 may be disposed on the third LM guide rail 153. The sixth plate 155 may be provided to be linearly movable along the third direction D3. The sixth plate 155 may be coupled to the third LM guide rail 153 through one or more third LM blocks 154. The holding unit 120 may be disposed on an upper surface of the sixth plate 155.

The fourth driving motor 156 may be provided on the sixth plate 155. The fourth driving motor 156 may linearly move the sixth plate 155 along the third direction D3. The fourth driving motor 156 may be connected to the controller.

The fourth driving motor 156 may move the sixth plate 155 in the third direction D3 in a state that the roll core 11 is seated on the pair of seating rollers 122. The fourth driving motor 156 may have a shape that serves as a power source for transferring the roll 10 to the stacker crane.

The pair of holding units 120 and the roll 10 seated on the pair of holding units 120 may linearly move integrally with each other along the third direction D3 by the actuation of the fourth driving motor 156 on both sides in the first direction D1.

The fourth driving motor 156 may include a second pinion 157 provided at a lower side of the sixth plate 155 in the second direction D2.

The second rack 158 may be provided on an inner side of any one of the pair of mounting frames 152 in the first direction D1. The second rack 158 may have a shape extended in the third direction D3.

The second rack 158 may constitute gear engagement with the second pinion 157 by the actuation of the fourth driving motor 156 by the controller.

The sixth plate 155 may move along the third direction D3 by gear engagement of the second rack 158 and the second pinion 157. The sixth plate 155 on which the holding unit 120 in the state that the roll core 11 is seated is disposed may be linearly moved by gear engagement of the second rack 158 and the second pinion 157.

That is, in a state that the roll core 11 is seated on the pair of holding units 120 again as the roll 10 aligned in the first direction D1 is lowered by descending of the pair of elevating units 130, the sixth plate 155 linearly moves in the third direction D3 by driving of the fourth driving motor 156 and thus the pair of holding units 120 also move in the third direction D3, whereby the roll 10 may be transferred to the stacker crane.

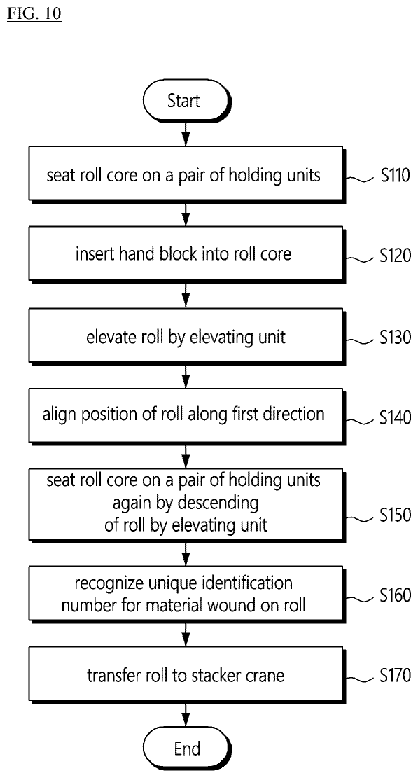

FIG. 10 is a flow chart illustrating a roll transfer method according to some embodiments of the present disclosure.

Referring to FIG. 10, the roll cores 11 on both sides of the roll 10 carried and stocked by an unmanned transport vehicle or a forklift are seated on the pair of holding units 120, respectively (S110).

The carried and stocked roll 10 may be disposed between the pair of holding units 120 spaced apart from each other in the first direction D1 to face each other. Subsequently, the roll cores 11 on both sides of the roll 10 are seated on the pair of holding units 120.

In a state that the roll core 11 is seated on the pair of seating rollers 122 of the holding unit 120, the controller actuates the third driving motor 146 of the alignment unit 140 so that the hand blocks B of the pair of alignment units 140 disposed on both sides of the roll 10 are inserted into the roll cores 11 on both sides of the roll 10 in the first direction D1, respectively.

As the fifth plate 143 (moving plate) moves in the first direction D1 by the driving of the third driving motor 146, the hand block B is also inserted into the roll core 11 while moving in the first direction D1 (S120).

The controller stops the insertion of the hand block B when the inner diameter detection sensor S of the hand block B inserted into the roll core 11 detects the inner diameter of the roll core 11.

The controller actuates the second driving motor 135 in a state that the hand block B is inserted into the roll core, so that the roll 10 is elevated in the second direction D2 by the pair of elevating units 130 spaced apart from each other in the first direction D1 (S130).

Subsequently, the controller calculates the distance from the initial position of each of the roll cores 11 on both sides in the first direction D1 to the position where the inner diameter detection sensor S detects the inner diameter of the roll core 11 in a state that the roll 10 is elevated to be eccentric along the first direction D1.

The controller allows the third driving motor 146 of each of the pair of alignment units 140 to be driven with different strokes in accordance with the calculated distance. The fifth plate 143 (moving plate), the extension frame 149 and the hand block B of each of the pair of alignment units 140 also move with different strokes integrally along the first direction D1 together with the roll 10 by the third driving motor 146 that is driven with different strokes, so that the roll 10 eccentric along the first direction D1 is aligned in the first direction D1 (S140).

When the position of the roll 10 is aligned along the first direction D1, the controller drives the second driving motor 135 again so that the roll 10 descends in the second direction D2 by the descending of the pair of elevating units 130 in the second direction D2 so that the roll cores 11 on both sides in the first direction D1 are seated again on the pair of holding units 120 (S150).

Subsequently, the controller actuates the first driving motor 124 to rotate any one of the pair of seating rollers 122, and the roll core 11 is rotated by the rotation of the seating roller 122 to rotate the roll 10.

When the roll core 11 is disposed at specific position in a state that the roll 10 and the roll core 11 are continuously rotated, the barcode reader recognizes the unique identification number provided at the specific position so that the material wound on the roll 10 may be recognized and transmits the recognition signal to the controller (S160).

When the unique identification number of the roll 10 is recognized, the controller stops the actuation of the first driving motor 124 to stop the rotation of the roll 10.

Subsequently, the controller actuates the fourth driving motor 156 to linearly move the sixth plate 155 along the third direction D3, so that the pair of holding units 120 disposed on the sixth plate 155 of each of the pair of transfer units 150 may also move linearly along the third direction D3 to transfer the roll 10 seated on the pair of holding units 120 to the stacker crane (S170).

When the transfer of the roll 10 is completed, the controller operates the fourth driving motor 156 again, so that the pair of holding units 120 may return to their original positions by moving the sixth plate 155 in a direction opposite to the third direction D3, whereby the alignment and transfer process of the roll 10 may be continuously performed.

As described above, in the roll transfer device and method according to some embodiments of the present disclosure, in a state that the roll 10 stocked in a left or right eccentric state is elevated through the elevating unit 130 to minimize friction, instead of pressing the roll core 11 with the same force from both left and right sides, the distance detected by the inner diameter detection sensor S is calculated from the initial position in which the roll core is stocked, so that alignment units 140 on both left and right sides move in a left-right direction with different strokes together with the roll 10 to align the roll, thereby making a centering work convenient and improving position accuracy during the transfer operation to increase reliability in the centering work of the roll 10.

Although the embodiments of the present disclosure have been described with reference to the accompanying drawings, it will be apparent to those skilled in the art that the present disclosure may be embodied in other specific forms without departing from the technical spirits and essential characteristics of the present disclosure. Thus, the above-described embodiments are to be considered in all respects as illustrative and not restrictive.

What is claimed is:

1. A roll transfer device comprising:
a plurality of frame units constituting an external appearance;
a pair of holding units spaced apart from each other in a first direction inside the frame unit, supporting a roll core seated thereon;
a pair of elevating units disposed on both upper sides in the first direction inside the frame unit to elevate a roll in a second direction and connected to each other by a first plate;
a pair of alignment units provided on the first plate and disposed on both sides in the first direction to align a position of the roll in the first direction; and
a pair of transfer units transferring the roll, in which the roll core is seated on the pair of holding units, in a third direction by simultaneously moving the pair of holding units in the third direction,
wherein the pair of alignment units linearly move along the first direction with different strokes to align the roll, in which the roll core is seated on the pair of holding units, in the first direction while being eccentric along the first direction.

2. The roll transfer device of claim 1, wherein the holding unit includes
a pair of second plates spaced apart from each other in the first direction,
a pair of seating rollers rotatably coupled to the pair of second plates by a shaft to rotate the roll core seated thereon, and
a first driving motor connected to any one of the pair of seating rollers by the shaft, a driving pulley and a timing belt to rotate any one of the pair of seating rollers.

3. The roll transfer device of claim 2, wherein the holding unit further includes a seating detection sensor for detecting seating of the roll core.

4. The roll transfer device of claim 2, further comprising a barcode reader that recognizes a unique identification code for a material wound on the roll through rotation of the roll by rotation of the roll core.

5. The roll transfer device of claim 1, wherein the elevating unit includes
a pair of first LM guide rails spaced apart from each other along the third direction on a third plate disposed on an upper portion inside the plurality of frame units along the first direction and extended along the second direction, and
a fourth plate coupled to the pair of first LM guide rails through one or more first LM blocks so as to linearly move along the second direction.

6. The roll transfer device of claim 5, wherein the elevating unit further includes
a second driving motor provided on the fourth plate, and
a first rack constituting gear engagement with a first pinion provided in the second driving motor.

7. The roll transfer device of claim 6, wherein the pair of elevating units, the first plate and the pair of alignment units are integrally elevated by driving of the second driving motor.

8. The roll transfer device of claim 1, wherein the alignment unit includes
a pair of second LM guide rails spaced apart from each other along the third direction on the first plate and extended along the first direction, and
a fifth plate coupled to the pair of second LM guide rails through one or more second LM blocks so as to linearly move along the first direction.

9. The roll transfer device of claim 8, wherein the alignment unit includes
a pair of support blocks provided to be adjacent to the second LM guide rail on the first plate and spaced apart from each other along the first direction,
a rotating shaft connecting the pair of support blocks,
a third driving motor connected to the rotating shaft through a coupler on the first plate to transfer a driving force to the rotating shaft, and
a carrier disposed on the rotating shaft and coupled to a lower surface of the fifth plate.

10. The roll transfer device of claim 9, wherein the first plate includes an opening formed at a position where the pair of second LM guide rails are spaced apart from each other, and
the alignment unit further includes
an extension frame provided on the lower surface of the fifth plate and extended downward by passing through the opening,
a hand block provided in the extension frame and inserted into the roll core seated on an upper portion of the holding unit, and
an inner diameter detection sensor provided inside the hand block to detect an inner diameter of the roll core.

11. The roll transfer device of claim 10, wherein, when the roll core is seated on the pair of holding units, the fifth plate linearly moves in the first direction by driving of the third driving motor and at the same time the extension frame and the hand block linearly move in the first direction to insert the hand block into the roll core, and
when the inner diameter detection sensor detects the inner diameter of the roll core, driving of the third driving motor is stopped so that the insertion of the hand block is stopped.

12. The roll transfer device of claim 11, wherein the roll is elevated by the pair of elevating units in a state that the hand block is inserted into the roll core, and
in a state that the roll is eccentric along the first direction, a distance from an initial position of each of the roll cores on both sides in the first direction to a position where the inner diameter detection sensor detects the inner diameter of the roll core is calculated so that the third driving motor of each of the pair of alignment units is driven with different strokes.

13. The roll transfer device of claim 12, wherein the fifth plate, the extension frame and the hand block of each of the pair of alignment units move along the first direction with different strokes together with the roll by the third driving motor to align the roll, which is eccentric along the first direction, in the first direction.

14. The roll transfer device of claim 1, wherein the pair of transfer units include worktables spaced apart from each other in the first direction and extended in the third direction, and the pair of holding units are disposed on upper surfaces of the worktable, respectively.

15. The roll transfer device of claim 14, wherein the transfer unit includes
a pair of mounting frames spaced apart from each other in the first direction on the upper surface of the worktable and extended in the third direction,
a third LM guide rail disposed on an upper surface of each of the pair of mounting frames and extended in the third direction, and
a sixth plate coupled to the pair of third LM guide rails through one or more third LM blocks to be linearly movable along the third direction, on which the holding unit is disposed.

16. The roll transfer device of claim 15, wherein the transfer unit includes
a fourth driving motor provided on the sixth plate,
a second pinion provided in the fourth driving motor, and
a second rack provided in any one of the pair of mounting frames to constitute gear engagement with the second pinion.

17. The roll transfer device of claim 16, wherein, in a state that the roll of which position is aligned in the first direction is lowered by descending of the pair of elevating units so that the roll core is seated again on the pair of holding units,
the sixth plate linearly moves in the third direction by driving of the fourth driving motor, so that the pair of holding units also moves in the third direction to transfer the roll.

18. The roll transfer device of claim 1, further comprising a cable veyor coupled to the elevating unit and the alignment unit through a bracket.

19. A roll transfer device comprising:
a plurality of holding units spaced apart from each other in a first direction, supporting a roll core seated thereon;
a pair of elevating units disposed on both upper sides in the first direction to elevate a roll in a second direction and connected to each other by a connection plate;
a pair of alignment units provided on the connection plate and disposed on both sides in the first direction to align a position of the roll in the first direction; and
a pair of transfer units transferring the roll, in which the roll core is seated on the pair of holding units, in a third direction by simultaneously moving the pair of holding units in the third direction,
wherein the alignment unit includes
a pair of LM guide rails spaced apart from each other along the third direction on the connection plate and extended along the first direction,
a moving plate coupled to the pair of LM guide rails through one or more LM blocks so as to linearly move along the first direction,
a pair of support blocks provided to be adjacent to the LM guide rail on the connection plate and spaced apart from each other along the first direction,
a rotating shaft connecting the pair of support blocks,
a driving motor connected to the rotating shaft through a coupler on the connection plate to transfer a driving force to the rotating shaft,
a carrier disposed on the rotating shaft and coupled to a lower surface of the moving plate,
an extension frame provided on the lower surface of the moving plate and extended downward by passing through an opening formed at a position, at which the pair of LM guide rails are spaced apart from each other, in the connection plate,
a hand block provided in the extension frame and inserted into the roll core seated on an upper portion of the holding unit, and
an inner diameter detection sensor provided inside the hand block to detect an inner diameter of the roll core,
when the roll core is seated on the pair of holding units, the moving plate linearly moves in the first direction by driving of the driving motor and at the same time the extension frame and the hand block linearly move in the first direction to insert the hand block into the roll core,
when the inner diameter detection sensor detects the inner diameter of the roll core, driving of the driving motor is stopped so that the insertion of the hand block is stopped,
the roll is elevated by the pair of elevating units in a state that the hand block is inserted into the roll core,
in a state that the roll is eccentric along the first direction, a distance from an initial position of each of the roll cores on both sides in the first direction to a position where the inner diameter detection sensor detects the inner diameter of the roll core is calculated so that the driving motor of each of the pair of alignment units is driven with different strokes, and
the fifth plate, the extension frame and the hand block of each of the pair of alignment units move along the first direction with different strokes together with the roll by the driving motor to align the roll, which is eccentric along the first direction, in the first direction.

20. A roll transfer method comprising:
seating a roll core on a pair of holding units at a position between the pair of holding units spaced apart from each other in a first direction by an unmanned transport vehicle or a forklift to face each other;
inserting a hand block of each of a pair of alignment units disposed at both sides of the roll core into the roll core at both sides of the roll in the first direction;
elevating the roll in the second direction by a pair of elevating units disposed to be spaced apart from each other in the first direction in a state that the hand block is inserted into the roll core;
aligning the roll along the first direction by driving each of the pair of alignment units with different scrolls to correspond to an initial position of each of the roll cores on both sides of the roll eccentric along the first direction;
seating the roll core on the pair of holding units again by descending the roll, which is aligned along the first direction, in the second direction by descending of the pair of elevating units along the second direction;
recognizing a unique identification number for a material wound on the roll through a barcode reader while rotating the roll core by rotation of any one of a pair of seating rollers respectively provided in the pair of holding units to seat the roll thereon; and
transferring the roll to a stacker crane by moving the pair of holding units in the third direction by movement of the pair of transfer units, in which the pair of holding units are respective disposed, in the third direction to move the roll, which is seated on the pair of holding units, in the third direction.
